(19) United States
(12) Patent Application Publication
(10) Pub. No.: US 2026/0309858 A1
(43) Pub. Date: Oct. 8, 2026

(54) Instantaneous Velocity Vector Estimation Using a Single MIMO Radar via Multi-Bounce Scattering

(71) Applicants: William Marsh Rice University, Houston, TX (US); The Regents of the University of California, Santa Barbara, CA (US)

(72) Inventors: Nishant MEHROTRA, Houston, TX (US); Ashutosh SABHARWAL, Houston, TX (US); Divyanshu PANDEY, Houston, TX (US); Upamanyu MADHOW, Santa Barbara, CA (US); Yasamin MOSTOFI, Santa Barbara, CA (US)

(73) Assignees: William Marsh Rice University, Houston, TX (US); The Regents of the University of California, Santa Barbara, CA (US)

(21) Appl. No.: 19/210,947

(22) Filed: May 16, 2025

Related U.S. Application Data
(60) Provisional application No. 63/649,076, filed on May 17, 2024.

(51) Int. Cl. G01S 13/58

(52) U.S. Cl. CPC G01S 13/584; G01S 13/589

(57) ABSTRACT

A method for instantaneous velocity estimation is disclosed. The method includes transmitting a plurality of orthogonal signals in a field-of-view of the radar and receiving a plurality of reflected signals, wherein the plurality of reflected signals includes single-bounce and multi-bounce signals of the plurality of orthogonal signals reflected from a plurality of surrounding objects. Further, the method includes determining locations of a plurality of moving objects and a plurality of Doppler frequencies and determining radial and tangential velocity components of the plurality of moving objects at the locations of the plurality of moving objects and the radial and tangential velocity components corresponding to the plurality of Doppler frequencies. Additionally, vector velocities of the plurality of moving objects are determined based on the plurality of Doppler frequencies and the radial and tangential velocity components corresponding to the plurality of Doppler frequencies.

### CROSS REFERENCE TO RELATED APPLICATIONS

This application claims priority to U.S. provisional patent application No. 63/649,076, filed May 17, 2024, which is herein incorporated by reference.

### STATEMENT REGARDING FEDERALLY SPONSORED RESEARCH OR DEVELOPMENT

This invention was made with government support under W911NF-19-2-0269 awarded by the Army Research Laboratory-Army Research Office, and 2215082, and 2211803 awarded by the National Science Foundation. The government has certain rights in the invention.

### BACKGROUND

Multiple Input Multiple Output (MIMO) radars may be used to estimate radial velocities of moving objects. However, the existing MIMO radars do not have the capability to determine tangential velocities of the moving objects without additional sensors or assumptions about the object size.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments disclosed herein relate to a method that includes transmitting, using a radar, a sum of a plurality of orthogonal signals in a field-of-view of the radar and receiving, using the radar, a plurality of reflected signals, wherein the plurality of reflected signals is the plurality of orthogonal signals reflected from a plurality of surrounding objects. Further, the method includes determining locations of a plurality of moving objects and a plurality of Doppler frequencies and determining tangential velocity components of the plurality of moving objects at locations of the plurality of moving objects and the tangential velocity components corresponding to the plurality of Doppler frequencies. Additionally, the method includes determining vector velocities of the plurality of moving objects based on the plurality of Doppler frequencies and the tangential velocity components corresponding to the plurality of Doppler frequencies.

In general, in one aspect, embodiments disclosed herein relate to a system including a millimeter wave radar, wherein the millimeter wave radar transmits a sum of a plurality of orthogonal signals in a field-of-view of the radar, and wherein the millimeter wave radar is configured to receive a plurality of reflected signals, wherein the plurality of reflected signals is the plurality of orthogonal signals reflected from a plurality of surrounding objects. Further, the system includes a computer communicably connected to the millimeter wave radar, the computer comprising a processor and a memory, the memory storing instructions that, when executed by the processor, cause the processor to determine locations of a plurality of moving objects and a plurality of Doppler frequencies and determine tangential velocity components of the plurality of moving objects at the locations of the plurality of moving objects and the tangential velocity components corresponding to the plurality of Doppler frequencies. Further, vector velocities of the plurality of moving objects are determined based on the plurality of Doppler frequencies and the tangential velocity components corresponding to the plurality of Doppler frequencies.

In general, in one aspect, embodiments disclosed herein relate to a non-transitory computer readable medium storing a set of instructions executable by a computer processor. The set of instructions includes the functionality for determining locations of a plurality of moving objects and a plurality of Doppler frequencies and determining tangential velocity components of the plurality of moving objects at the locations of the plurality of moving objects and the tangential velocity components corresponding to the plurality of Doppler frequencies. Further, vector velocities of the plurality of moving objects are determined based on the plurality of Doppler frequencies and the tangential velocity components corresponding to the plurality of Doppler frequencies.

### BRIEF DESCRIPTION OF DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 shows a single-bounce system according to embodiments of the present disclosure.

FIG. 2 shows a double-bounce system according to embodiments of the present disclosure.

FIG. 3 shows a flowchart in accordance with one or more embodiments.

FIG. 4 shows a flowchart in accordance with one or more embodiments.

FIG. 5 shows a computer system in accordance with one or more embodiments.

### DETAILED DESCRIPTION

Embodiments disclosed herein generally relate to a multi-bounce scattering. Further, one or more embodiments disclosed herein relate to a multi-bounce scattering method that exploits multi-bounce scattering in the environment to enable estimating a moving object's entire velocity vector, including tangential and radial velocities. Further, the proposed method enables instantaneous velocity vector estimation with a single MIMO radar, without additional sensors or assumptions about the object size. As used herein “include” means “include, but is not limited to”.

This disclosure describes a method that exploits multi-bounce scattering in the environment to enable estimating a moving object's entire velocity vector, both tangential and radial velocities. Classical approaches to the velocity vector estimation problem involve tracking targets over multiple frames. However, such methods require multiple frames to converge to reliable estimates, and hence may not provide instantaneous velocity vector estimates in every frame. The proposed method enables instantaneous velocity vector estimation with a single MIMO radar, without additional sensors or assumptions about the object size.

The only requirement of the method is the existence of at least one resolvable multi-bounce path to the object from a static landmark in the environment. Further, the method exploits all orders of multi-bounce paths and requires no additional hardware or prior knowledge about the environment.

This disclosure's method of using the multi-bounce for velocity vector estimation is novel and has not been used before. The classical approaches to the problem involve tracking targets over multiple frames. However, classical methods require multiple frames to converge to reliable estimates. As such, they may not provide instantaneous velocity vector estimates in every frame.

Other prior work has approaches have explored complementary ideas for instantaneous velocity vector estimation with single-bounce models. However, such methods require utilizing multiple cooperative radars, fusing measurements from a radar and camera, or require extended targets spanning multiple resolution bins. Additionally, the traditional radar signal processing models line-of-sight (LOS) scattering from objects that are directly illuminated by the radar and scatter the illumination back. The LOS radar processing enables estimating the range and radial velocity of objects, as well as their azimuth and elevation angles, when the radar is equipped with multiple transmit and receive antennas, often labeled as multiple input, multiple output (MIMO) radar. However, the LOS radar processing cannot estimate the tangential velocities of moving objects. No tangential velocity estimation limits radar performance in scenarios where objects move tangentially to the radar, such as cross-moving cars and pedestrians at a traffic intersection.

In one or more embodiments, the method described in this disclosure enables instantaneous velocity vector estimation with a single MIMO radar, without additional sensors or assumptions about the object size.

In one or more embodiments, this disclosure relates to scenarios including, but not limited to, autonomous driving. In such scenarios, estimating the position and velocity of moving objects in the environment (e.g., pedestrians or other vehicles) is critical to ensure non-hazardous operation. Amongst multiple sensing systems for such tasks under consideration by the automotive industry, radio detection and ranging (e.g., radar) systems are an integral part due to their ability to penetrate through impediments such as fog and smoke, which occlude object positioning and velocity estimation with light-based systems, such as cameras and light detection and ranging (e.g., lidar) systems.

In one aspect, one or more embodiments the method exploits the presence of static objects in the environment that result in multi-bounce scattering from a moving object in their vicinity. The disclosure includes a three-stage procedure to estimate the velocity vector of the moving object from multi-bounce returns at the radar.

Radar systems operate by radiating electromagnetic signals in radio and microwave frequencies into the environment and receiving reflections of radiated signals from objects in the environment. The reflected signals received at the radar are used to estimate the position and velocity of a moving object with respect to the radar system. In particular, radar systems utilize the time shift between the transmitted and received signal to estimate the object's position with respect to the radar. In a similar fashion, the frequency shift between the transmitted and received signals is used to estimate the object's velocity with respect to the radar.

Conventional radar signal processing assumes the signals transmitted by the radar reflect once off an object in the environment before being received at the radar receiver, henceforth termed single-bounce radar processing. A feature of single-bounce radar signal processing is that the Doppler shift observed at the radar system is proportional to the projection of the moving object's velocity vector on an imaginary line joining the radar system to the object, henceforth termed the moving object's radial velocity, as depicted in two dimensions (2D)

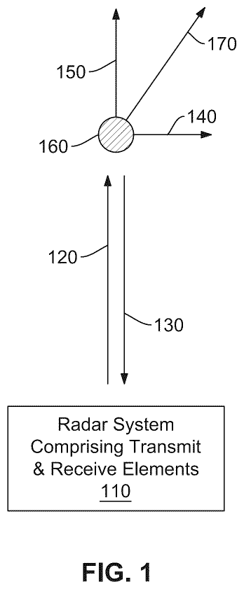

FIG. 1 shows a diagram of a system in one or more embodiments. The system includes the MIMO radar (110) is capable of emitting frequency-modulated continuous wave (FMCW) chirps and receiving reflected signals. The co-located transmit and receive antenna arrays form the hardware infrastructure necessary to perform both single-bounce and multi-bounce Doppler processing for estimating velocity vectors of moving objects. The MIMO radar (110) transmits signal (120) that consists of a sequence of frequency-modulated continuous wave (FMCW) chirps that are emitted during a single radar frame. These signals (120) interact with objects in the environment, producing reflected signals that can follow single-bounce or multiple-bounce paths before returning to the radar. The single-bounce path is a path that signal travels from the radar to the object and back to the radar. The multiple-bounce path is a path that the signal travels from the radar to a first object and so on to n^{th} object, back to first object then radar.

Further, the moving object (160) represents a target whose motion the system aims to measure. The object may a non-rotating rigid body and moves within a 2D range-azimuth plane. The object's motion is characterized by a two-dimensional velocity vector (170), consisting of radial (150) and tangential (140) components with respect to the radar. The radial velocity is the component of the object's velocity that aligns with the radar's line-of-sight. The radial component may be measured based on the single-bounce Doppler measurements. The tangential velocity is the component of object's velocity that lies tangentially to the radar's line-of-sight. Tangential component is not measurable through single-bounce path alone. Instead, the estimation of tangential component requires the use of multi-bounce scattering paths involving reflections from secondary static objects in the environment. The single-bounce reflected signal from the moving object (130) represents the radar return signal that follows a single-bounce path, from radar to object to radar.

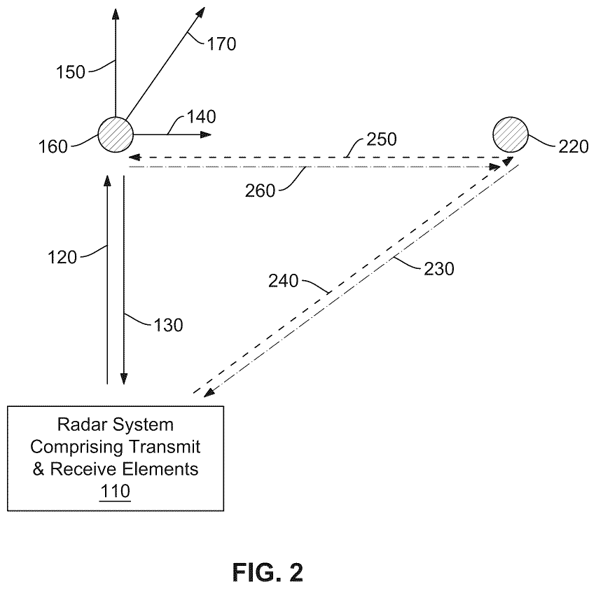

FIG. 2 shows a diagram of velocity vector estimation of a moving object in one or more embodiments. In addition to the single-bounce described in FIG. 1, FIG. 2 shows a radar (110) transmitting signal (230) to a static object (220). The signal (230) reflects from the static object (220) and reflected signal (250) travels to the moving object (150). The signal (250) again reflects from the moving object (150) and a second reflected signal (260) travels back to the static object (220), which reflects it back to the radar (110) as a third reflected signal (240).

As such, this disclosure exploits multi-bounce signals and enables a single MIMO radar to estimate the single-frame velocity vectors of moving objects in the environment. The radial (150) velocity of the moving object (150) is captured in conventional FFT-based Doppler processing. The tangential velocity is captured using a multi-bounce path calculation.

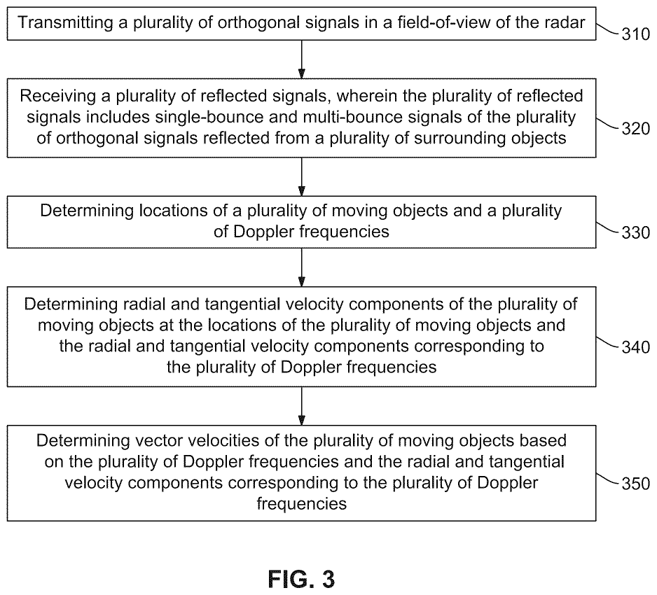

Turning to FIG. 3, FIG. 3 shows a flowchart in one or more embodiments. Specifically, in Step 310, a the MIMO radar transmits a plurality of FMCW chirps during a single radar frame. The radar is equipped with a T-antenna transmit array and an R-antenna receive array. Each of the T transmit antennas emits FMCW chirps in a time-orthogonal fashion. The transmitted signals share a common starting frequency and duration per chirp but are orthogonal in time to prevent interference between transmit channels.

Further, the collection of chirps transmitted within a single radar frame spans multiple frequency samples. Each radar frame is comprised of a number of chirps, typically between 64 and 256, transmitted within a time duration on the order of 10 milliseconds. The transmission is directed into the field-of-view of the radar, where it can interact with various objects in the surrounding environment, including both moving and static reflectors.

In some embodiments, transmitting the orthogonal signals enables the radar to later resolve both spatial and Doppler information through coherent processing of the received echoes. These signals serve as the basis for extracting Doppler shifts due to object motion, and for distinguishing between different propagation paths, including single-bounce and multi-bounce components. The orthogonality and structured timing of these chirps are critical for enabling the separation of signal returns in the presence of multiple overlapping scattering paths.

In Step 320, a plurality of reflected signals is received. The plurality of reflected signals includes signals resulting from single-bounce and multi-bounce scattering paths of the plurality of orthogonal signals reflected from a plurality of surrounding objects. Specifically, the MIMO radar receives reflections of the transmitted FMCW chirps at its R-element receive antenna array. The received signals consist of multi-bounce components created from interactions between the transmitted signals and various objects in the environment. These include both moving objects, such as pedestrians or cyclists, and static objects, such as walls, pillars, or parked vehicles.

The received signals include contributions from both single-bounce and multi-bounce scattering paths. A single-bounce path refers to a line-of-sight (LOS) trajectory where the signal reflects off a moving object and returns directly to the radar. These paths carry information about the radial velocity component of the object along the radar's line-of-sight.

In addition, the received signals include multi-bounce components, particularly double-bounce and triple-bounce paths. In a double-bounce path, the radar signal reflects off a moving object and then a static object, or vice versa, before returning to the radar. These paths enable observation of the object's motion from different propagation directions and therefore contain information related to the tangential velocity component. Triple-bounce paths involve two reflections from either the moving or static object.

Together, the single-bounce and multi-bounce reflected signals are received as a combined signal at each receive antenna. The result is a data cube indexed by receive element, frequency or time, and chirp index. These received signals, which contain overlapping components from various paths and directions, serve as the raw input to the Doppler and spatial processing steps necessary for estimating the full velocity vector of the moving objects.

In one or more embodiments, the single-bounce and multi-bounce Doppler components are extracted in cases when bounce locations are unknown. Further, the weak multi-bounce signals are extracted based to the power decay. To extract the single-bounce and multi-bounce Doppler components, the static objects are mapped in a multi-stage algorithm. The algorithm initially maps moving objects and estimates single-bounce Doppler velocities. Then, it identifies background reflection points and estimates Doppler velocities along multi-bounce paths. Finally, it estimates object velocity vectors based on a custom clustering algorithm. In some embodiments, the weak multi-bounce signal extraction is addressed by sequentially processing Doppler signals, starting with higher-power lower-order bounces, to isolate and extract higher-order components.

The following equation describes the relation between the observed Doppler shift f_{SB} and the moving object's velocity vector v:

$${f}_{SB} = \frac{2 {f}_{c}}{c} {n}_{SB}^{T} v$$

where

$${n}_{SB}^{T}$$

indicates the unit normal towards the moving object's location r_{SB},

$${n}_{SB} = \frac{{r}_{SB}}{‖ {n}_{SB} ‖} ,$$

f_{c} denotes the center frequency of radar illumination and c denotes the speed of light.

Further, the perpendicular component of the moving object's velocity vector (140)

$${v}_{tng} = v - ( {n}_{SB}^{T} v ) {n}_{SB} ,$$

representing the moving object's velocity vector (140) captured and hence cannot be estimated by single-bounce radar signal processing. It is evident that in scenarios with large tangential velocities, for instance cross-traffic due to pedestrians walking across a zebra crossing or vehicles moving at a traffic intersection, the radial velocity (150) estimates accorded by single-bounce radar signal processing may be misleading and may lead to hazards in autonomous driving.

In Step 330, the plurality of moving objects and the plurality of Doppler frequencies are determined. Specifically, the single-bounce and multi-bounce scattering is analyzed to estimate both the spatial locations and Doppler characteristics of moving objects. Initially, a grid of candidate spatial locations is formed in the 2D range-azimuth plane. For each grid point, the processor performs matched filtering using the received signal and an expected signal template corresponding to a hypothetical reflector at that location. This filtering incorporates known array steering vectors and propagation delay models based on the radar's geometry.

For each grid point, the processor computes a Doppler frequency spectrum by applying a Doppler fast Fourier transform (FFT) across the sequence of FMCW chirps transmitted within the radar frame. The frequency corresponding to the peak response in this spectrum is identified as the single-bounce Doppler frequency for that spatial location. This Doppler frequency captures the projection of the object's velocity along the radar's line-of-sight at that point.

After generating a map of reflectivities and associated Doppler frequencies across the spatial grid, the processor applies clustering algorithms, such as DBSCAN, to group closely located grid points with similar Doppler characteristics. These clusters are interpreted as candidate moving objects. Each cluster's constituent points provide an initial estimate of the object's spatial extent and a set of associated Doppler measurements. These measurements are used as the basis for further velocity vector estimation, enabling the radar to simultaneously localize multiple moving objects and associate them with corresponding Doppler frequency shifts, even within a single radar frame.

In one or more embodiments, the following formula is used to determine the single-bounce paths:

$$( {f}_{1} , {r}_{m} ) = arg {max}_{f , p} \frac{1}{W} {\sum }_{ω = 1}^{W} Re \{ {( {y}_{1}^{P} ( ω ) )}^{H} F ( y ) ( ω ; f ) \} , \qquad ( Equation 1 )$$

where F(y)(ω; f) denotes the Doppler FFT of the radar measurements the residual single-bounce terms y(ω; [symbol] ) taken over the transmitted chirps. Further,

$${Y}_{1}^{p} ( w )$$

represents Doppler-independent factors due to scattering from object along the path, which may be understood as transmit and receive beamforming towards hypothetical grid locations p, and compensating for the single-bounce path delay to and from p. The grid location p and Doppler bin f with the highest matched filter output magnitude yield the moving object's location rm and the corresponding single-bounce Doppler term f₁.

In one or more embodiments, after estimating the moving objects location (rₘ), and the Doppler term f₁, the radar next sequentially estimates the multi-bounce Doppler term f₂ as following:

$${f}_{2} = arg {max}_{f} \frac{1}{W} {\sum }_{ω = 1}^{W} Re \{ {( {y}_{2}^{{r}_{m} , {r}_{s}} ( ω ) )}^{H} ℱ ( y ) ( ω ; f ) \} , \qquad ( Equation 2 )$$

In Step 340, both the radial and tangential components of velocity are determined for each detected moving object, using the previously estimated locations and Doppler frequencies. The radial velocity component at a given location is directly estimated from the single-bounce Doppler frequency, which corresponds to the projection of the object's motion along the line-of-sight between the radar and the object. This estimation is straightforward and follows from standard Doppler radar principles.

To estimate the tangential velocity component, the component of the object's motion orthogonal to the line-of-sight, the multi-bounce paths have to be analyzed, specifically double-bounce and triple-bounce scattering paths involving static objects in the environment. These paths capture signal reflections that have different propagation directions relative to the moving object's motion, and thus provide access to different linear projections of the velocity vector.

The candidate multi-bounce paths are identified by combining the estimated locations of moving objects with known or previously mapped positions of static objects. For each moving-static object pair, the matched filtering is applied to detect Doppler frequencies arising from double-bounce paths, such as radar to moving object to static object to radar, or radar to static object to moving object to radar. Additionally, the triple-bounce paths are also considered.

Each multi-bounce path provides a distinct Doppler measurement that represents a different directional projection of the object's velocity vector. By aggregating Doppler information across single-bounce and multi-bounce paths, and by associating each Doppler frequency with its corresponding propagation geometry, both the radial and tangential velocity components of each moving object are determined at their respective spatial locations.

In Step 350, the Doppler frequency measurements, obtained from both single-bounce and multi-bounce scattering paths, are combined with the known geometric relationships among the radar, moving objects, and static reflectors to estimate the full velocity vector for each moving object. The velocity vector comprises both the radial and tangential components, which together define the object's motion in the 2D range-azimuth plane relative to the radar.

The method formulates and solves a least-squares optimization problem, as follows

$$v = arg {min}_{w} {‖ [ \begin{matrix}{f}_{1} \\ {f}_{2} \\ {f}_{3 , l} \\ {f}_{3 , ll}\end{matrix} ] + \frac{1}{{λ}_{c}} [ \begin{matrix}\frac{2 {r}_{m}^{T}}{{‖ {r}_{m} ‖}_{3}} \\ \frac{{r}_{m}^{T}}{{‖ {r}_{m} ‖}_{2}} + \frac{{( {r}_{m} - {r}_{s} )}^{T}}{{‖ {r}_{m} - {r}_{s} ‖}_{2}} \\ \frac{2 {r}_{m}^{T}}{{‖ {r}_{m} ‖}_{2}} + \frac{2 {( {r}_{m} - {r}_{s} )}^{T}}{{‖ {r}_{m} - {r}_{s} ‖}_{3}} \\ \frac{2 {( {r}_{m} - {r}_{s} )}^{T}}{{‖ {r}_{m} - {r}_{s} ‖}_{2}}\end{matrix} ] w ‖}_{2}^{2} . \qquad ( Equation 3 )$$

For Doppler terms f₁, f₂, and f₃ and moving object's location rₘ and static object's location rₛ, to recover the velocity vector from multiple linear constraints derived from the Doppler frequency expressions for each scattering path. Each Doppler frequency corresponds to a linear projection of the object's velocity vector onto the direction of propagation of a particular path segment, whether it is single-bounce or multi-bounce. By aggregating these measurements across different path geometries, a linear system is constructed in which the velocity vector is determined.

In practice, the radar system collects Doppler frequencies from one or more single-bounce paths and multiple double-bounce and triple-bounce paths. The system then identifies the set of multi-bounce measurements that provide the diversity of reflecting signals for velocity vector estimation. The paths involving reflections off static reflectors that are not linear with each other with the radar and moving object yield the most favorable geometry, specifically when they form approximate right angles.

Once all relevant Doppler measurements are gathered and associated with their respective propagation paths, the processor solves the optimization problem to estimate the velocity vector of each moving object. The final output is a two-dimensional velocity vector for each object, resolved from a single radar frame and without the need for multiple hardware modules or multi-frame tracking.

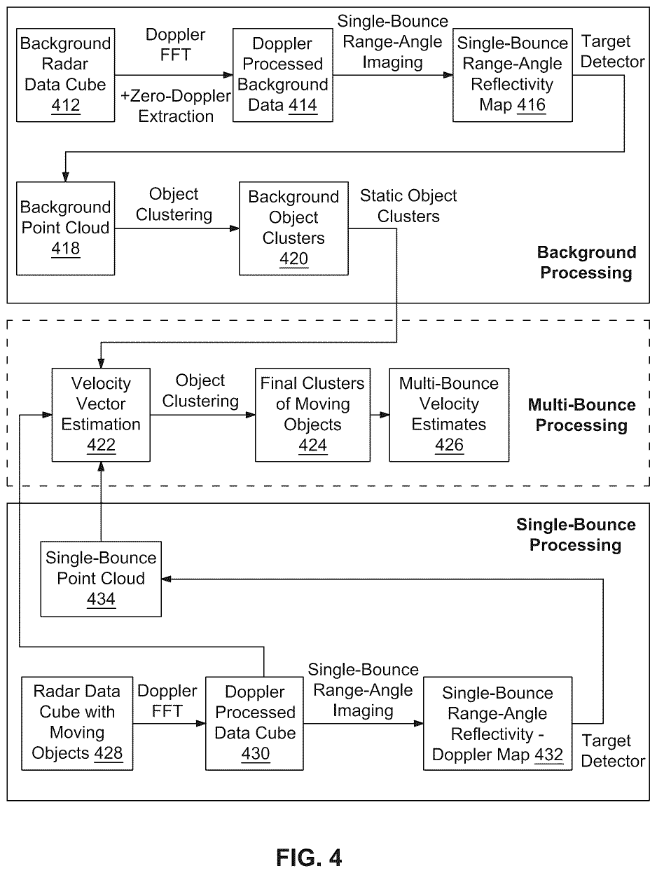

FIG. 4 shows a diagram illustrating the overall functionality of the proposed method in one or more embodiments. In one or more embodiments with only a single MIMO radar available, the first stage may be performed by capturing radar data in the absence of any moving object.

In one or more embodiments, in the background processing stage, the radar processes the received signals to obtain a radar point cloud of objects in the background using a sequence of radar signal processing steps depicted in the flow-chart above, comprising Doppler domain FFTs, zero Doppler extraction, range-angle MIMO radar imaging via appropriate algorithms, including, but not limited to, range-angle domain FFT and Fourier back projection, object detection via algorithms, including, but not limited to, constant false alarm detectors, which are segmented into clusters via appropriate methods including, but not limited to, density-based spatial clustering approaches.

In one or more embodiments, the proposed method includes, but is not limited to, at least three distinct stages. The first stage includes, but is not limited to, detecting and localizing static objects in the environment in the absence of any moving object using single-bounce radar signal processing. In Block 412, the raw radar data is collected during a radar frame in which one or more moving objects are present in the environment. The data cube is structured over three axes, the receive antenna index, frequency or time sample within a chirp, and chirp index. It contains signal reflections resulting from single-bounce and multi-bounce paths involving both static and moving scatterers.

Further in Block 414, the received data is processed based on the Doppler FFT processing to extract frequency-domain information across chirps. To isolate reflections from static objects, a zero-Doppler extraction is applied, removing any components that may be due to residual dynamic elements. The result of this step is the Doppler processed background data, which contains Doppler information attributed exclusively to stationary reflectors. This data is then passed through a single-bounce range-angle imaging in Block 416, generating a single-bounce range-angle reflectivity map that localizes the positions of static reflectors in the environment.

In Block 418, the detected points from this map are grouped into a background point cloud, which consists of reflectivity estimates for candidate reflector positions. The background point cloud is then passed through an object clustering algorithm in Block 420 to generate background object clusters. These clusters are further filtered to produce static object clusters, which represent the known environment structure used for identifying multi-bounce propagation paths.

Separately, in Block 428, a radar data cube with moving objects is collected during active sensing in environment that contains moving targets. Similar to background processing, this data is first transformed using a Doppler FFT in Block 430 to obtain a Doppler processed data cube, which encodes per-frequency Doppler components over spatial locations. In Block 432, the processed data is passed through single-bounce range-angle imaging, followed by generation of a single-bounce range-angle reflectivity Doppler map, which contains both range-azimuth position and associated single-bounce Doppler values. From this map, a target detector extracts significant signal reflections, producing a single-bounce point cloud in Block 434. Each point in this cloud is associated with an estimated position and a corresponding single-bounce Doppler frequency. This point cloud serves as the input to further velocity calculations. The single-bounce point cloud is clustered using an object clustering step, yielding the final clusters of moving objects. Each cluster contains radar returns associated with a distinct moving target and includes the locations and single-bounce Doppler frequencies of its constituent points.

In Block 422, the single-bounce point cloud clusters, along with the static object clusters identified during background processing, serve as inputs to multi-bounce processing. Specifically, the system evaluates candidate double-bounce and triple-bounce signal paths between each moving object and static object. For each valid path, multi-bounce Doppler processing is applied using matched filtering across possible Doppler frequencies and path geometries, generating the multi-bounce velocity estimates. These estimates correspond to Doppler frequencies resulting from multi-bounce paths and are used to supplement the information captured in single-bounce measurements.

Further, the velocity vector estimation Block 422 aggregates Doppler frequencies from both single-bounce and multi-bounce paths. For each point in the moving object clusters, a least-squares optimization is solved to estimate the full two-dimensional velocity vector. This estimation fuses Doppler projections arising from distinct path directions, including both line-of-sight and indirect reflections, enabling accurate single-frame recovery of both radial and tangential components of motion.

In Block 424, the objects are clustered based on the estimated velocity vector. Each cluster corresponds to a moving object and includes estimated position. These clusters are the basis for estimation of multi-bounce velocity estimates in Block 426. Specifically, the multi-bounce velocity estimates are derived based on the double-bounce and triple-bounce scattering paths between points in the final clusters of moving objects and static object clusters.

The method described in this disclosure may be utilized in a variety of applications. The method may be used to aid vehicles and traffic infrastructure, such as smart traffic lights, and traffic radars. Specifically, the method may aid the vehicles and the traffic infrastructure in estimating the velocity of cross traffic and help with enabling more intelligent traffic scheduling and aid individual drivers and/or vehicles during parking.

Additionally, this disclosure may be used to help with human activity, vital signs detection, and monitoring across industries such as emergency services, indoor gaming, home/factory floor monitoring, security, etc. More specifically, this disclosure may enable the radar to use natural multipath in the environment to estimate the gestures, movement and vital signs of people even when they may be oriented perpendicular to the radar.

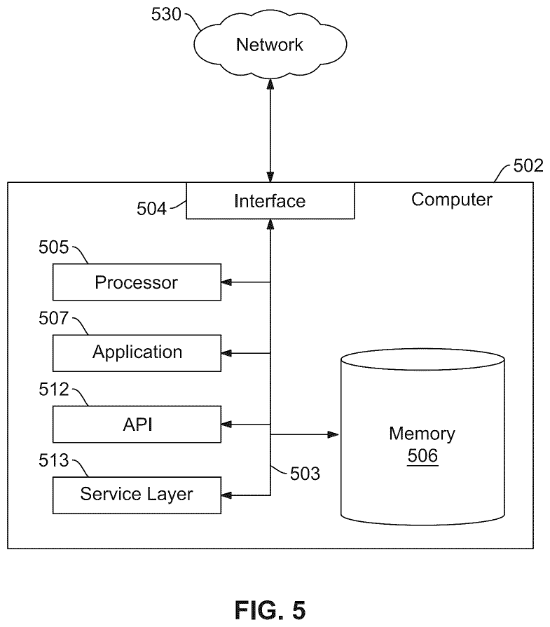

FIG. 5 depicts a block diagram of a computer system (502) used to provide computational functionalities, control functionalities, or both associated with algorithms, methods, functions, processes, flows, and procedures in this disclosure, according to one or more embodiments. The illustrated computer (502) is intended to encompass any suitable computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (502) may include a computer that includes an input device, such as a keypad, keyboard, touch screen, or other device that can accept user information, and an output device that conveys information associated with the operation of the computer (502), including digital data, visual, or audio information (or a combination of information), or a GUI.

The computer (502) can serve in a role as a client, network component, a server, a database or other persistency, or any other suitable component (or a combination of roles) of a computer system for performing the subject matter described in the instant disclosure. The illustrated computer (502) is communicably coupled with a network (530). In some implementations, one or more components of the computer (502) may be configured to operate within environments, including cloud-computing-based, local, global, or other environment (or a combination of environments).

At a high level, the computer (502) is an electronic computing device operable to receive, transmit, process, store, or manage data and information associated with the described subject matter. According to some implementations, the computer (502) may also include or be communicably coupled with an application server, e-mail server, web server, caching server, streaming data server, business intelligence (BI) server, or other server (or a combination of servers).

The computer (502) can receive requests over network (530) from a client application (for example, executing on another computer (502) and responding to the received requests by processing the said requests in an appropriate software application. In addition, requests may also be sent to the computer (502) from internal users (for example, from a command console or by other appropriate access method), external or third-parties, other automated applications, as well as any other appropriate entities, individuals, systems, or computers.

Each of the components of the computer (502) can communicate using a system bus (503). In some implementations, any or all of the components of the computer (502), both hardware or software (or a combination of hardware and software), may interface with each other or the interface (504) (or a combination of both) over the system bus (503) using an application programming interface (API) (512) or a service layer (513) (or a combination of the API (512) and service layer (513). The API (512) may include specifications for routines, data structures, and object classes. The API (512) may be either computer-language independent or dependent and refer to a complete interface, a single function, or even a set of APIs. The service layer (513) provides software services to the computer (502) or other components (whether or not illustrated) that are communicably coupled to the computer (502). The functionality of the computer (502) may be accessible for all service consumers using this service layer. Software services, such as those provided by the service layer (513), provide reusable, defined business functionalities through a defined interface. For example, the interface may be software written in JAVA, C++, or other suitable language providing data in extensible markup language (XML) format or another suitable format. While illustrated as an integrated component of the computer (502), alternative implementations may illustrate the API (512) or the service layer (513) as stand-alone components in relation to other components of the computer (502) or other components (whether or not illustrated) that are communicably coupled to the computer (502). Moreover, any or all parts of the API (512) or the service layer (513) may be implemented as child or sub-modules of another software module, enterprise application, or hardware module without departing from the scope of this disclosure.

The computer (502) includes an interface (504). Although illustrated as a single interface (504) in FIG. 5, two or more interfaces (504) may be used according to particular needs, desires, or particular implementations of the computer (502). The interface (504) is used by the computer (502) for communicating with other systems in a distributed environment that are connected to the network (530). Generally, the interface (504) includes logic encoded in software or hardware (or a combination of software and hardware) and operable to communicate with the network (530). More specifically, the interface (504) may include software supporting one or more communication protocols associated with communications such that the network (530) or interface's hardware is operable to communicate physical signals within and outside of the illustrated computer (502).

The computer (502) includes at least one computer system (505). Although illustrated as a single computer system (505) in FIG. 5, two or more processors may be used according to particular needs, desires, or particular implementations of the computer (502). Generally, the computer system (505) executes instructions and manipulates data to perform the operations of the computer (502) and any algorithms, methods, functions, processes, flows, and procedures as described in the instant disclosure.

The computer (502) also includes a memory (506) that holds data for the computer (502) or other components (or a combination of both) that can be connected to the network (530). For example, memory (506) can be a database storing data consistent with this disclosure. Although illustrated as a single memory (506) in FIG. 5, two or more memories may be used according to particular needs, desires, or particular implementations of the computer (502) and the described functionality. While memory (506) is illustrated as an integral component of the computer (502), in alternative implementations, memory (506) can be external to the computer (502).

The application (507) is an algorithmic software engine providing functionality according to particular needs, desires, or particular implementations of the computer (502), particularly with respect to functionality described in this disclosure. For example, application (507) can serve as one or more components, modules, applications, etc. Further, although illustrated as a single application (507), the application (507) may be implemented as multiple applications (507) on the computer (502). In addition, although illustrated as integral to the computer (502), in alternative implementations, the application (507) can be external to the computer (502).

There may be any number of computers (502) associated with, or external to, a computer system containing computer (502), wherein each computer (502) communicates over network (530). Further, the term “client,” “user,” and other appropriate terminology may be used interchangeably as appropriate without departing from the scope of this disclosure. Moreover, this disclosure contemplates that many users may use one computer (502), or that one user may use multiple computers (502).

### EXAMPLES

Examples according to one or more embodiments disclosed herein are provided in Appendix A.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
transmitting, using a radar, a plurality of orthogonal signals in a field-of-view of the radar;
receiving, using the radar, a plurality of reflected signals, wherein the plurality of reflected signals includes single-bounce and multi-bounce signals of the plurality of orthogonal signals reflected from a plurality of surrounding objects;
determining, using a computer processor, locations of a plurality of moving objects and a plurality of Doppler frequencies;
determining, using the computer processor, radial and tangential velocity components of the plurality of moving objects at the locations of the plurality of moving objects and the radial and tangential velocity components corresponding to the plurality of Doppler frequencies;
determining, using the computer processor, vector velocities of the plurality of moving objects based on the plurality of Doppler frequencies and the radial and tangential velocity components corresponding to the plurality of Doppler frequencies.

2. The method of claim 1, wherein the locations of the plurality of moving objects and the plurality of Doppler frequencies corresponding to single-bounce scattering paths are determined based on a spatio-temporal matched filter radar processing.

3. The method of claim 1, wherein the plurality of Doppler frequencies corresponding to double-bounce scattering paths at the locations of the plurality of moving objects are determined using a double-bounce matched filtering.

4. The method of claim 1, wherein the vector velocities are determined using a least-squares inversion process.

5. A system, comprising:
a millimeter wave radar,
wherein the millimeter wave radar transmits a plurality of orthogonal signals in a field-of-view of the radar, and
wherein the millimeter wave radar is configured to receive a plurality of reflected signals, wherein the plurality of reflected signals is the plurality of orthogonal signals reflected from a plurality of surrounding objects; and
a computer communicably connected to the millimeter wave radar, the computer comprising a processor and a memory, the memory storing instructions that, when executed by the processor, cause the processor to:
determining locations of a plurality of moving objects and a plurality of Doppler frequencies;
determining radial and tangential velocity components of the plurality of moving objects at the location of the plurality of moving objects and the radial and tangential velocity components corresponding to the plurality of Doppler frequencies;
determining vector velocities of the plurality of moving objects based on the plurality of Doppler frequencies and the radial and tangential velocity components corresponding to the plurality of Doppler frequencies.

6. The system of claim 5, wherein the memory stores instructions, that, when executed by the processor, cause the processor to determine the locations of the plurality of moving objects and the plurality of Doppler frequencies corresponding to single-bounce scattering paths based on a spatio-temporal matched filter radar processing.

7. The system of claim 5, wherein the memory stores instructions, that, when executed by the processor, cause the processor to determine the plurality of Doppler frequencies corresponding to double-bounce scattering paths at the locations of the plurality of moving objects using a double-bounce matched filtering.

8. The system of claim 5, wherein the memory stores instructions, that, when executed by the processor, cause the processor to determine the vector velocity using a least-squares inversion problem.

9. A non-transitory computer-readable medium storing instructions that, when executed by a processor, cause the processor to perform a method comprising:
determining locations of a plurality of moving objects and a plurality of Doppler frequencies;
determining radial and tangential velocity components of the plurality of moving objects at the location of the plurality of moving objects and the tangential velocity components corresponding to the plurality of Doppler frequencies;
determining vector velocities of the plurality of moving objects based on the plurality of Doppler frequencies and the tangential velocity components corresponding to the plurality of Doppler frequencies.

10. The non-transitory computer-readable medium of claim 9, wherein the instructions, that, when executed by the processor, cause the processor to determine the locations of the plurality of moving objects and the plurality of Doppler frequencies corresponding to single-bounce scattering paths based on a spatio-temporal matched filter radar processing.

11. The non-transitory computer-readable medium of claim 9, wherein the instructions, that, when executed by the processor, cause the processor to determine the plurality of Doppler frequencies corresponding to double-bounce scattering paths at the locations of the plurality of moving objects using a double-bounce matched filtering.

12. The non-transitory computer-readable medium of claim 9, wherein the instructions, that, when executed by the processor, cause the processor to determine the vector velocity using a least-squares inversion problem.
